(19) United States
(12) Patent Application Publication
(10) Pub. No.: US 2008/0167881 A1
(43) Pub. Date: Jul. 10, 2008

(54) Method for Two-Channel Coding of a Message

(76) Inventor: Bertrand Haas, New Haven, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/885,232

(22) PCT Filed: Feb. 3, 2006
(86) PCT No.: PCT/US06/04207

§ 371 Date: Aug. 28, 2007

Related U.S. Application Data
(60) Provisional application No. 60/649,865, filed on Feb. 3, 2005.

(51) Int. Cl. G10L 19/00

(52) U.S. Cl. 704/500

(57) ABSTRACT

A method for encoding a message including the steps of performing two-channel encoding of the message into a robust string and a fragile string; transmitting the robust string through a fragile channel; and transmitting the fragile string though a robust channel (FIG. 6). Before the step of performing two-channel encoding of the message into a robust string and a fragile string the number of characters in the message may be reduced to reduce the size of the encode message. The two channel encoding step includes the steps of creating the robust string by encoding the message using the codeword dictionary; and creating the fragile string by encoding the message using a compression algorithm. The robust string may be transmitted by embedding the robust string in an image. The fragile string may be transmitted by embedding the fragile string in a 2-D bar code.

### FIELD OF THE INVENTION

The invention disclosed herein relates generally to a method for compressing a message, and more particularly to method for two-channel coding of a message.

### BACKGROUND OF THE INVENTION

The preferred situation in Claude Shanon's Theory of Communication is that of a single channel. However, in many real life applications it makes sense to distinguish between two or more channels during communication. For instance, it is often the case that the accuracy of transmission of an image is much higher than the human accuracy of perception. This allows the transmission of subliminal information at the same time than the intended human perceivable image information. Information Hiding (watermarking and steganography) extensively uses the subliminal channel capacity (while lossy data compression tends to reduce it). However, data hidden in images is often more sensitive to degradation due to noise. In other words, the subliminal channel is more fragile.

Most of Shanon's communication theory deals with transmitting a message through a single channel. However, in many applications, two or more channels are available for transmission with the property that one channel is more robust (to noise) but has limited capacity, and the other is more fragile but has larger capacity.

On the one hand, the message to be sent may be too long, if uncompressed, to be sent by one or the other channel only. On the other hand, efficient compression techniques (in particular, variable length encoding, like Huffman's) may allow it to be sent through the larger capacity channel, but make it sensitive to errors (for example, one bit error in Huffman encoding corrupts the rest of the message). Since this channel is also fragile (i.e., bit errors are likely to occur), the message is likely to be un-retrievable.

### SUMMARY OF THE INVENTION

The instant invention relates to the situation where two or more parallel channels of different capacity and different robustness to noise are simultaneously used to communicate a message. The instant invention takes advantage of the two-channel scheme by decomposing the message both into a short fragile part which will be sent through the robust capacity-limited channel and into a longer robust part which will be sent through the fragile larger-capacity channel. In this manner, the instant invention provides a scheme that takes advantage of this situation to combine compression and error handling.

The instant invention is demonstrated herein through the context of physical mail where an indicium printed on a mailpiece contains a known two dimensional (2-D) DataMatrix barcode with IBI information and an image of high enough complexity that allows a relatively large amount of data to be reliably hidden in the image. A description of printing a 2-D barcode with IBI information on a physical mailpiece is described, for example, in U.S. Pat. Nos. 5,930,796 and 6,175,827, which are incorporated herein in their entirety by reference.

It is known to encode the recipient address information in the indicium for the purpose of fraud mitigation. See for example, U.S. patent application Ser. No. 10/456,416 filed Jun. 6, 2003 (Publication No. 04-0128254), which are incorporated herein in its entirety by reference. The particular problem that the application addresses is that the IBI information encoded in the barcode may allow only 20 bytes to be used for the address hash. It then proposes to hash the address to 20 bytes after stripping them from frequently recurring words like “Street”, “Ave.”, etc. Experiments on a sample of 3,000 regular addresses showed collisions of the order of 1 out of 1,000. In regards of the large amount of mail processed this may lead to a costly too many false positive fraud detection. Some points increasing the collision likelihood are as follows:
At the verification point, the hashed address is retrieved from the barcode, the printed (or hand-written) address is OCR-read, hashed again, and the new hash is compared with the retrieved hash. Since OCR errors may occur, chances are that the new hash will be different than the retrieved one. Therefore, a standard hashing algorithm cannot be used and the patent proposes a “forgiving” hash algorithm (where some defining properties of a hash are weakened) which may lead to collisions.
Since a non-standard hashing algorithm is used, direct hashing may not be the best encoding scheme from an information theoretic standpoint. Indeed, the redundant information contained in addresses may increase the likelihood of hash collisions. A better encoding scheme consists in first removing the redundant information by an appropriate compression algorithm, and only then proceeding to hashing.
Frequently recurring words like “Street”, “Ave.”, etc., even if they carry less information than names, zip codes, etc, do carry some relative information. By discarding them, one may therefore discard some useful information that could avoid collisions.

The invention embodiment described herein takes advantage of the particular situation of having an indicium with an image, such as a photograph, and uses two-channel coding in order to code as much as possible from the whole address, thereby avoiding the pitfalls of the “forgiving hash” described above.

In accordance with the instant invention, a message (in the embodiment described, an address) is treated as a string of ascii characters. For the purpose of limiting or controlling the size of a coded message, it may be advantageous to shrink the character alphabet used for encoding the messge. In particular, ascii characters that are not expected in an address may be disregarded. In addition, all upper case characters may be converted to lower case characters. However, there may be benefits to expanding the alphabet by considering pairs of character that are strongly correlated as new characters (such as “th”), which may further limit or control the size of the coded message. This should be tested on a large enough sample of messages.

After the character alphabet is established, a frequency count of the characters is made, and a codeword dictionary is constructed in which the codewords consist in all binary strings up to a certain length and where shorter codewords are associated with more frequent characters.

The message is then encoded into 2 strings, a “robust” string by assembling a codeword associated with each character in the message into a long binary string, and a “fragile” string that sequentially encodes the bit length of the codewords in the robust string. (The detailed description provides an explanation of the words “robust” and “fragile”). Decoding this pair of strings is straightforward.

The fragile string is intended to be encoded through a robust channel, and the robust string through a fragile channel. In order to gain more capacity, the fragile string is further compressed using a known algorithm such as Huffman.

### DESCRIPTION OF THE DRAWINGS

The accompanying drawings, which are incorporated in and constitute a part of the specification, illustrate presently preferred embodiments of the invention, and together with the general discription given above and the detailed description of the preferred embodiments given below, serve to explain the principles of the invention. As shown throughout the drawings, like reference numerals designate like or corresponding parts.

FIG. 1 is a representative postage indicium including a two dimensional bacode and an image;

FIG. 2 is a histogram showing a frequency count for each expected character and order them from most frequent to least frequent as used in a sample list of addresses;

FIG. 3 is a bar graph showing length distribution of fragile strings for the sample list of addresses used in FIG. 2;

FIG. 4 is a histogram of the fragile string alphabet for the sample list of addresses used in FIG. 2;

FIG. 5 is a Huffman tree from the histogram of the fragile string alphabet of FIG. 3 for the fragile strings from the sample list of addresses used in FIG. 2;

FIG. 6 is a histogram of bit length distribution of the robust strings from the sample list of addresses used in FIG. 2;

FIG. 7 is a flow chart for a two-channel encoder in accordance with the instant invention;

FIG. 8 is a flow chart for construction of the 2-channel codeword dictionary in accordance with the instant invention; and

FIG. 9 is a flow chart for construction of the Huffman codeword dictionary in accordance with the instant invention.

### DETAILED DESCRIPTION OF THE INSTANT INVENTION

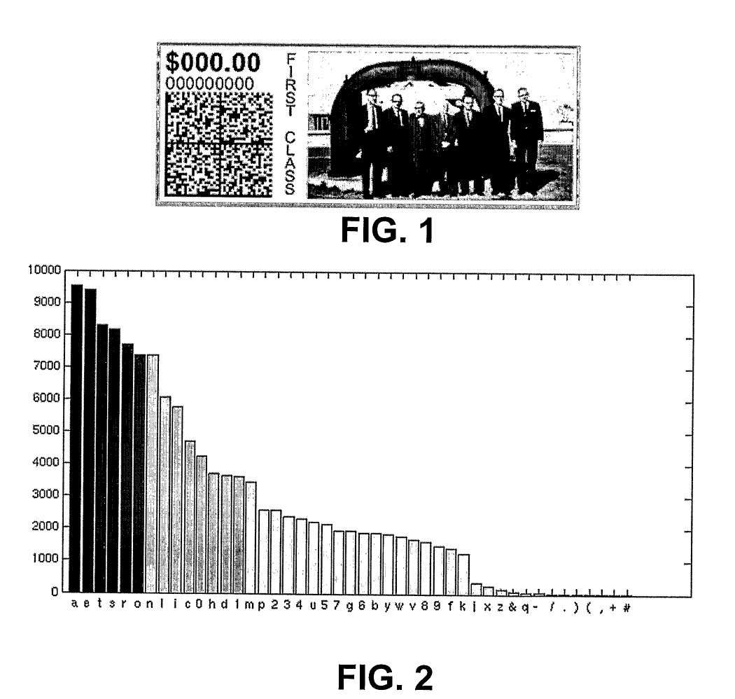

In describing the instant invention, reference is made to the drawings, wherein there is seen in FIG. 1 a postal indicium and in FIGS. 2-8 various graphs and flow charts that are used in describing the instant invention.

The instant invention considers two coexisting channels, one fragile and one robust. If the robust channel had much larger capacity than the fragile one, the advantage of using both would fade out. The instant invention considers some capacity constraint on the robust channel relative to the fragile one. This is exactly the situation in the physical postal application described below in section “Application to a Physical Mail System”.

For simplicity of exposition, the instant invention is described in the context of a transmission of an alphanumeric message (with an alphabet of more than 2 characters) coded as a binary string. The generation of a message is often modeled according to the iid (Independent Identically Distributed random variables) model. It is a convenient model since it is easy to work with, but it is mostly a first approximation, in particular for English text, where correlation between characters is clear (for example “t” and “h” are often adjacent). For clarity of exposition, the instant invention includes a compression scheme within the iid model, but it is understood that some additional steps would make it work as well in a more accurate model. For instance, the alphabet can be expanded to include pairs of characters that are highly correlated (like “th”).

A long message has to be compressed before being transmitted through any channel. The best compression algorithms usually use binary strings of variable lengths to encode characters. A typical compression algorithm is Huffman coding. It is probably the best algorithm in the iid model, but it suffers from “fragility” (like most variable length coding). Indeed if a bit error occurs in the compressed binary string during transmission, the rest of the message is mostly unrecoverable. To avoid this problem, a good error correction algorithm is necessary; with the obvious drawback of size increase. This combination of compression and error correction results in removing useless redundancy and adding useful ones. However, in many applications, error correction is too much of a luxury, as the increased size of the message becomes prohibitive, and softer error handling is sufficient. For instance, electronic packet transmission often requires only error detection; if an error is detected the packet is retransmitted. In some applications, a few errors might be tolerable and only error containment is sufficient, that is, a bit error only affects the corresponding codeword and not the rest of the message.

### The Compression Algorithm

The compression algorithm in accordance with the instant invention takes advantage of the presence of a robust channel of lower capacity and a fragile channel of higher capacity. The output of the compression is a pair of binary strings: a shorter fragile (in the same sense as in Huffman coding) string that is intended to be sent through the robust channel and a longer robust (in the sense of error containment) string that is intended to be sent through the fragile channel. Thus, the instant invention combines efficient compression and error handling in one step.

The variable input of the algorithm is a string of characters and the output is a pair (robust string, fragile string). The parameter input are two dictionaries (which are made public). A large sample of messages is desired in order to gather the statistic parameters necessary to construct these dictionaries.

### The First Codeword Dictionary

Let m be the size of the character alphabet. A character frequency count on a large sample of initial messages is first performed. The characters are then ordered by decreasing frequency. A code dictionary is then constructed by associating binary strings to the characters in the following way: The characters between the positions 2i−1 and 2i+1−2 are associated with all the binary strings of length i (up to the length of the alphabet). The order in which the strings are associated to the characters within this range is unimportant for the sole purpose of compression. So the two first (therefore most frequent) characters are coded with the length one strings “0” and “1”.

### The Robust and the Raw Fragile String

From an initial message (a string of characters), a binary robust string is produced simply by replacing the characters of the messages by the corresponding codewords of the first dictionary. At the same time, a “raw” fragile string (non binary) is produced by sequentially recording the bit length of the codewords for each character of the message. To decode the pair of strings, one places periods in the robust string at the positions specified by the fragile string. This delimitates the codewords, and one can then replace each codeword by its associated character using the first dictionary. The reason why the two strings are called “robust” and “fragile” now becomes clear: If one error occurs in the fragile string all the periods there and after will be shifted, and the rest of the robust string will be wrongly decoded. If one bit error occurs in the robust string, then the error is confined to its codeword and does not affect the rest of the decoding.

### The Second Codeword Dictionary and the Fragile String

The raw fragile string still has to be encoded to produce the final binary string. Here the characters of the raw fragile string are lengths of codewords of the first dictionary. So if L1 is the length of the first alphabet (the characters for the initial messages), the length L2 of the second alphabet (the characters for the raw fragile strings) is: .

L2=ceil(log 2(L1))

that is, substantially smaller than L1. So the second alphabet can be coded with ceil(log 2(L2)) bits per character. However, a better result can be obtained by compressing again the raw fragile string. Since the correlation between lengths of codewords in the robust string can be expected to be much lower than the correlation between codewords themselves, the iid model can be expected to be rather good for the generation of raw fragile strings. Huffman coding is therefore a natural choice. Moreover, the raw fragile string being already fragile in the sense described above, encoding it with the Huffman algorithm will not really make it more fragile. The large sample of raw fragile strings is used to construct the Huffman tree and the associated dictionary (referred to herein as the second dictionary). Raw fragile strings can then now be Huffman encoded to produce the final fragile strings.

### Application to a Physical Mail System

An indicium is a postage label that is printed directly on the mail piece (or perhaps on a sticker to be appended to the mail piece) and that acts as a proof of payment for the postal service. The instant invention assumes the generation by a printer-meter of an indicium that contains several parts, among which only two are of interest for our purpose: a variable grey level image of high enough complexity so that a substantial amount of information can reliably be hidden in it; and a two dimensional DataMatrix barcode with some standard information (meter identification number, some meter accounting data, postage denomination, etc.) encoded and cryptographically signed.

Referring now to FIG. 1, the instant invention is described herein through the context of physical mail where an indicium printed on a mailpiece contains a known two dimensional (2-D) DataMatrix barcode with IBI information and an image of high enough complexity that allows a relatively large amount of data to be reliably hidden in the image. One advantage of the instant invention is when a given IBI barcode is already signed. The fragile string encoded in it can then not be cryptographically protected. In order to protect the address encoding, the robust string may be cryptographically protected by using a watermark with a key to embed it in the image.

The indicia consists in an image (of sufficient complexity) and a 2 dimensional DataMatrix barcode. Other information on the indicium are irrelevant for the purpose of demonstrating the invention here. The barcode represents the robust channel. Indeed, it is designed to be machine read after being printed on a broad range of paper quality with low end printers; Moreover its built-in Reed Solomon error correction algorithm allows it to be correctly read even after substantial deteriorations.

The image together with some watermarking or steganographic algorithm represents a more fragile channel. Indeed, after printing, aging, possible deterioration and scanning, the message embedded in the image is often recovered with errors.

### The Robust and the Fragile Channels

The data capacity of a barcode is mostly taken by the standard information and the cryptographic signature, and only 20 bytes are available to embed other kinds of information. Since the DataMatrix barcode is a very simple monochrome graphic designed to be read by a machine after being printed on papers from a wide range of quality, and since it has error correction (Reed-Solomon) built-in, it can be considered a robust channel, with limited capacity (20 bytes) for our purpose.

The fragile channel is the image together with a watermarking algorithm that allows having a minimum of 30 bytes of information embedded into it. The print and scan process always distorts the image and introduces errors when the hidden information is retrieved. In particular, even though the ink in the printer with which the indicium is printed is of high quality, the paper on which it is printed is not under control. As a result, the printed image may suffer from poor ink-paper interaction. However, a watermarking algorithm that encodes each bit of the message in a block ca be used, whereby it is assumed that in recovering the message, bits may be misread but not missed.

### The Purpose of Two-Channel Compression for the Application

In the printer-meter under consideration the recipient addresses are also printed on the mail pieces (at the same handling time than the indicium, but with a different print head). The occasion to include also some information about the address (for more thorough verification) is not missed, but the preferred way is usually to hash the address to 20 bytes and include the hash in the barcode. The main drawback is that at verification point the address is OCR-read (Optical Character Recognition) and some errors may occur. The resulting hash is then very different than the hash in the barcode and when the two are compared, the mail piece is marked for further investigation. In accordance with the instant invention, the two-channel coding described above encodes the full address, instead of a hash, in both the barcode and the image. At verification point, the address retrieved by decompression is then compared to the OCR-read one, and only in cases where the two are very different will the mail piece be out-streamed. In order to fit the address into the allowed 20 bytes of robust channel and 32 bytes of fragile channel, the address is first transformed by concatenating the three address lines, removing all white characters and making all alphabetic characters upper case. The result is referred to herein as the initial (address) string.

### The Compression Results on Addresses

The dictionaries referred to herein were constructed using a sample of 3,000 regular addresses. The results are as follows. For simplicity, white characters were eliminated and upper case characters were replaced with lower case characters. Referring now to FIG. 2, the frequency distribution of the remaining characters is shown in a bar graph. The dictionary inferred from these frequencies is shown on Table 1 below. Robust strings and fragile raw strings are then computed. The distribution of the codeword lengths is shown in Table 2 below together with the deduced Huffman dictionary for the fragile strings.

Referring to FIG. 1 for the character frequency distribution, a code C is constructed as follows: the first two characters in the distribution (“a” and “e”) are encoded by “0” and “1”; the next four characters (“t”, “s”, “r”, “o”) are encoded by “00”, “01”, “11”, “10”, the next eight characters (from “n”, to “1”are encoded by all the binary strings of length 3, and so on until the code “dictionary” in Table 1 is completed.

TABLE 1

| | | | | | |
|---|---|---|---|---|---|
| ‘a’ | ‘0’ | ‘p’ | ‘0001’ | ‘f’ | ‘00000’ |
| ‘e’ | ‘1’ | ‘2’ | ‘0010’ | ‘k’ | ‘00001’ |
| ‘t’ | ‘00’ | ‘3’ | ‘0011’ | ‘j’ | ‘00010’ |
| ‘s’ | ‘01’ | ‘4’ | ‘0100’ | ‘x’ | ‘00011’ |
| ‘r’ | ‘10’ | ‘u’ | ‘0101’ | ‘z’ | ‘00100’ |
| ‘o’ | ‘11’ | ‘5’ | ‘0110’ | ‘&’ | ‘00101’ |
| ‘n’ | ‘000’ | ‘7’ | ‘0111’ | ‘q’ | ‘00110’ |
| ‘l’ | ‘001’ | ‘g’ | ‘1000’ | ‘-’ | ‘00111’ |
| ‘i’ | ‘010’ | ‘6’ | ‘1001’ | ‘/’ | ‘01000’ |
| ‘c’ | ‘100’ | ‘b’ | ‘1010’ | ‘.’ | ‘01001’ |
| ‘0’ | ‘011’ | ‘y’ | ‘1011’ | ‘)’ | ‘01010’ |
| ‘h’ | ‘100’ | ‘w’ | ‘1100’ | ‘(’ | ‘01011’ |
| ‘d’ | ‘101’ | ‘v’ | ‘1101’ | ‘,’ | ‘01100’ |
| ‘1’ | ‘110’ | ‘8’ | ‘1110’ | ‘+’ | ‘01101’ |
| ‘m’ | ‘0000’ | ‘9’ | ‘1111’ | ‘#’ | ‘01110’ |

TABLE 2

| | | |
|---|---|---|
| ‘3’ | 39064 | 11 |
| ‘4’ | 33661 | 10 |
| ‘2’ | 31517 | 01 |
| ‘1’ | 18931 | 001 |
| ‘5’ | 3663 | 000 |

To encode an address A, a first string is constructed by substituting each character of the address with the corresponding binary code described above. A second string is constructed by recording for each character of the address the number of binary digits used to encode it.

For instance the address
Bertrand Haas
1234 Fifth Avenue
La Bella Citta, AB 09876
   is first transformed into the lower case string:
“bertrandhaas1234fifthavenuelabellacita,ab09876”
   and then each character is substituted with the corresponding binary codeword to result in the string which produces the robust 128 bits string:
1010110001000001101010001111001000110100000
0001000000001010110110000101100101010100100
1001101000001100010101001111111001111001
   and the 109 bits fragile string:
1000101010100111111100100101111010100001100
0011100110001111000111001100011111001111101
01001000001101110101010

### Statistical Results

Table 3 provides a summary of the mean, standard deviation, minimum and maximum, of the bit lengths of the following: The initial address encoded with 8 bits, the robust strings, the fragile strings, and to gauge the compression efficiency, the total length (the sum of the two previous) to be compared with the length of the full Huffman encoded addresses. These parameters were collected on the same sample of 3,000 addresses that were used to construct the dictionaries.

TABLE 3

| | mean | std. dev. | min. | max. |
|---|---|---|---|---|
| initial addrress | 338.1 | 55.4 | 160 | 568 |
| robust string | 117.3 | 19.2 | 64 | 193 |
| fragile string | 92 | 15.6 | 41 | 158 |
| total length | 209.3 | 34.2 | 1-5 | 347 |
| Huffman encoded | 202 | 32.6 | 100 | 344 |

The maximal length for the robust strings, 193 bits, is below the capacity of the watermark (32×8=256 bits), and the mean length, 117.3 bits, is less than half this capacity. This means that optionally some redundancy can be added, in the form of error correction coding, to the addresses to make them more robust to the print scan channel.

The maximum length of the fragile string, 158 bits, is right below the allowed capacity of the barcode (20×8=160). It may happen that an address produces a fragile string longer than 160 bits even though some user limitations to the length of the address input is embedded in the printer. In that case, it is always possible to crop the initial address string of some characters in order to shorten the fragile string below 161 bits.

The compression rate (length of compressed address divided by length of initial address) averages 61.9% for two-channel coding and 59.8% for Huffman coding. Thus, 1.1% in compression rate is lost, but error robustness for 56% of the compressed message is gained. That is a good trade-off.

To decode the first string above, periods are placed in the first string, at the positions prescribed by the second string to retrieve the codewords:
1010.1.10.00.10.0.000.110.101.0.0.01.111.0010.0011.0100.000
00.010.00000.00.101.0.1101.1.000.0101.1.001.0.1010.1.001.00
1.0.011.010.00.0.01100.0.1010.100.1111.1110.0111.1001
   Then the first dictionary in Table 1 is used to recreate the address string “bertrandhaas1234fifthavenuelabellacita,ab09876”.

On the one hand, notice that an error in the second string would compromise the rest of the decoded string in a similar fashion than with Huffman encoding. This is why it is called the “fragile” string. On the other hand, notice that a bit error in the first string would remain contained in the codeword where it occurs and leave the rest of the codewords unaffected. This is it is called the robust string.

Notice that the maximal length of a codeword is 6 which is smaller than 8=2̂3, so the alphabet {“1”, “2”, “3”, “4”, “5”, “6”} can be encoded with at most 3 bits. More generally if an address A has m non-white characters, the first string has bit length 3*m. So addresses A with more than 53 non-white characters (160/3=53.333 . . .) may pose a problem to fit first string in a barcode.

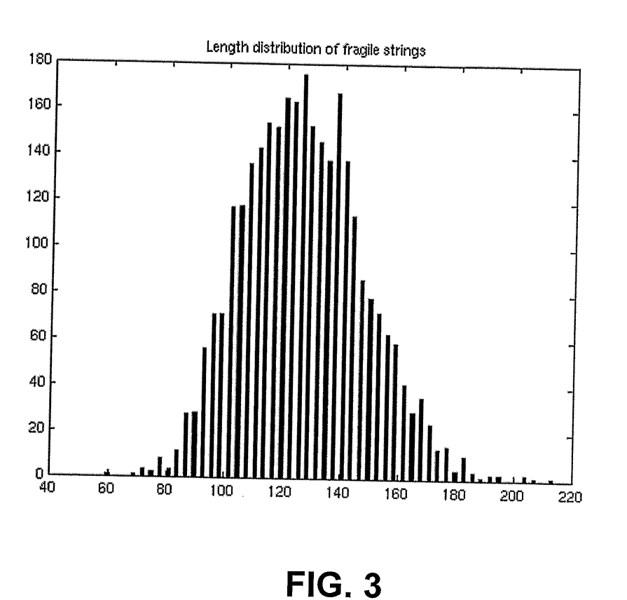

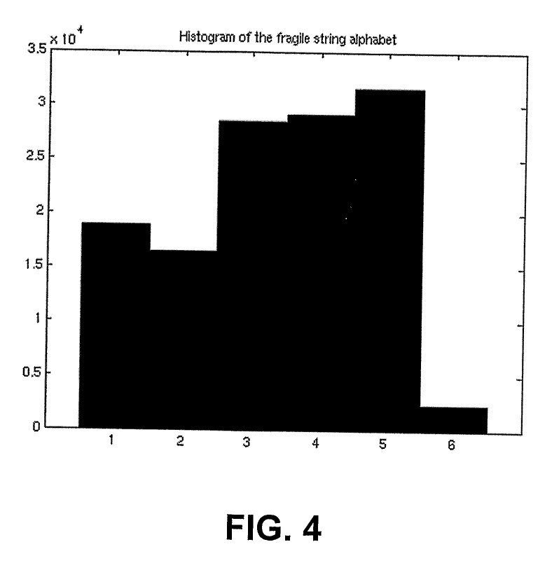

From the 3,000 address sample used to produce the first dictionary, the distribution of bit length of the fragile string is shown in FIG. 3. The mean is 126.7 and the proportion of lengths above 160 bits is 182/3000=6%.
One way to solve this problem is to crop the addresses to 53 characters.
Another way is to use better compression. Indeed, for simplicity the character distribution in addresses is approximated with an iid model (Independent, Identically Distributed random variables) that is it is assumed that characters are uncorrelated with each others. This is a common approximation (Huffman coding for instance is based on an iid model) but it well known that many characters in the English language are correlated (for instance “t” and “h” often occur adjacently). So to better the algorithm the alphabet is extended with common adjacent pairs of letters as new characters (for instance “th”).
Yet another way is to compress the fragile string. Several reasons concur to use Huffman coding for that purpose:
   Codeword lengths certainly have less correlation than the characters themselves, so the simple iid model sounds appropriate
   words of middle length are more likely to occur (see FIG. 4.)
   The fragile string cannot be made more “fragile” by Huffman coding, and it's “fragility” is taken care of by the error correction in the DataMatrix coding.

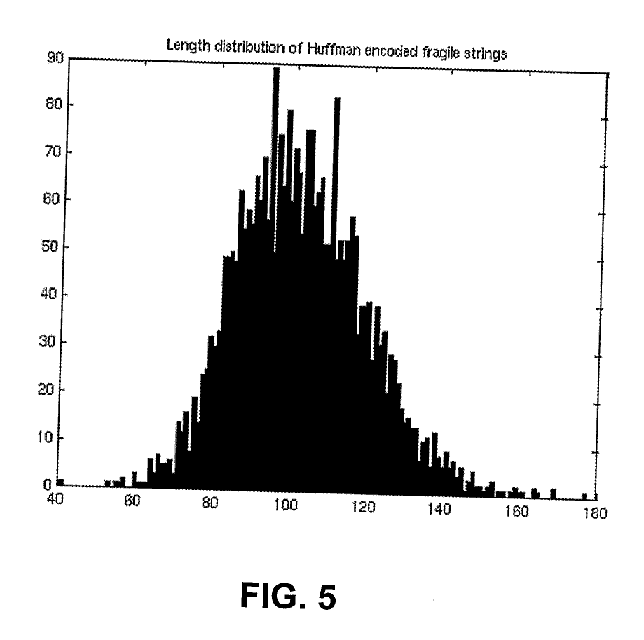

Huffman tree is constructed from the histogram of the fragile string alphabet (FIG. 4) and encoded the fragile strings from all the 3,000 addresses. The bit length distribution of the strings dropped in average by 19% (see FIG. 5). Now the mean length is 102.5 and the number of addresses with bit length above 160 is 0.2%. The (much fewer) addresses that are too long to have their fragile strings compressed in the allowed 20 bytes of the barcodes, can be cropped character by character until it fits.

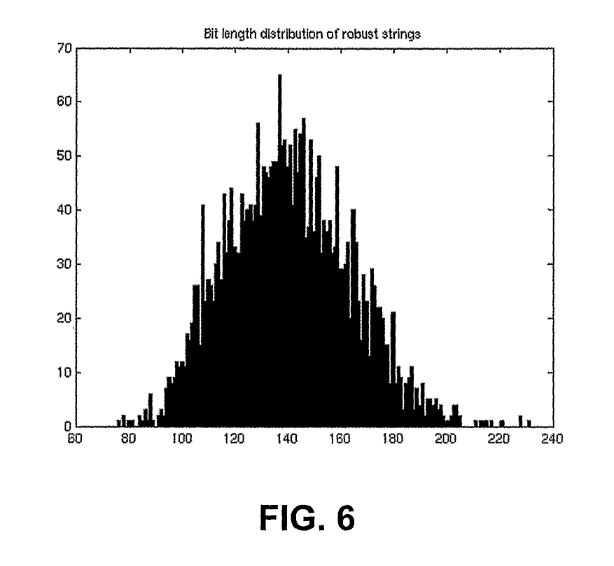

The bit length of the robust string has a distribution shown on FIG. 6. Its mean is 140 bits and maximum is 231. Since it will be encoded in a fragile channel (in the image with a watermark algorithm), it will be coded with an error correction algorithm which may increase its size by 2 fold. Among all the 3,000 addresses about 0.7% had a robust string that was longer, once error correction encoded, than the 50 allowed bytes that was an assumed limit. Here again for the very few addresses for which this occurs, some character cropping would solve the problem.

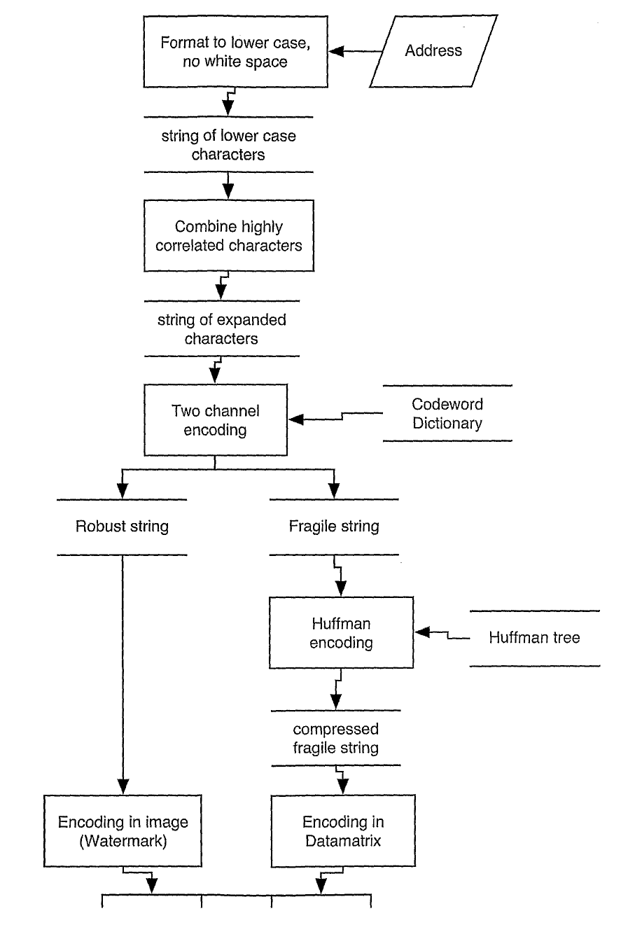

Referring now to FIG. 7, a two-channel encoder process in accordance with the instant invention is described. The address is formatted to lower case and white spaces are eliminated to produce a string of lower case characters. Optionally, highly correlated characters can be combined to correspond to such combined characters in the codeword dictionary. This produces a string of expanded characters. Next, the two channel encoding is done as described above using the codeword dictionary to produce a robust string and a fragile string. The robust string is encoded into an image. The fragile string goes through Huffman encoding using a Huffman tree to produce a compressed fragile string which is then encoded into a Datamatrix barcode. The image and the barcode are printed as part of an indicium on a mailpiece.

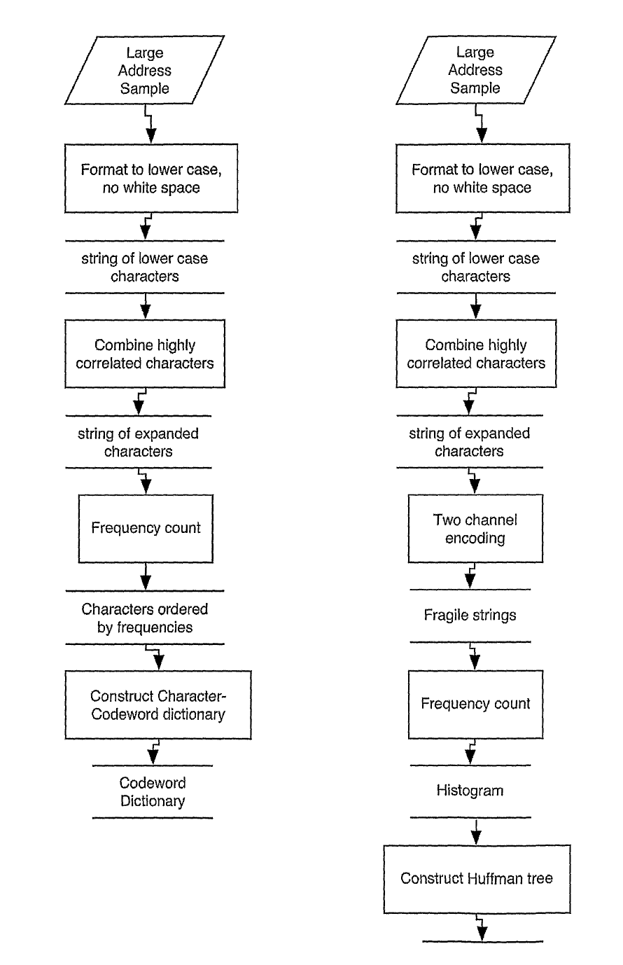

Referring now to FIG. 8, the construction of the 2-channel codeword dictionary in accordance with the instant invention is described. Using a large sample of addresses (for example, 3000), the addresses are formatted to lower case and white spaces are eliminated to produce a string of lower case characters for each of the addresses. Optionally, for each of the addresses, highly correlated characters are combined to produce a string of expanded characters. A frequency count is made of each of the characters in the string and the characters are listed in order by frequencies. The character codeware dictionary is constructed as described above.

Referring now to FIG. 9, the construction of the Huffman codeword dictionary in accordance with the instant invention is described. Using a large sample of addresses (for example, 3000), the addresses are formatted to lower case and white spaces are eliminated to produce a string of lower case characters for each of the addresses. Optionally, for each of the addresses, highly correlated characters are combined to produce a string of expanded characters. Two-channel encoding is performed to produce fragile strings for the addresses. A frequency count is made of each of the characters in the string is made to produce a histogram. The large sample of raw fragile strings is used to construct the Huffman tree and the associated dictionary (referred to herein as the second dictionary).

### The MATLAB Scripts

Included below are two MATLAB scripts used to implement the compression algorithm. They both input a 3×n cell array (the three rows correspond to the standard three lines of the addresses, and the n columns to n addresses; n should be large for the first script. The first script produces a structure C with fileds C.alphab (the alphabet of the initial address strings), C.freq (the frequencies of the alphabet characters), and C.cwords (the codewords associated to the alphabet characters). The alphabet and codewords are ordered by decreasing frequencies. The second script encodes addresses and takes also as input the code computed by the first script, and the Huffman dictionary (to be computed with another script). The output is a structure B with fields B.rob (the robust string) and B.frag (the fragile string).

function C = makeTCcode(A)
S = strcat(A{:});
S = upper(S); S = regexprep(S,’ ’ ,’’};
numS = uint8(S);
freq = hist(numS, 32:126);
pos = find(freq);
alphcar = char(pos+31);
alphcell = cellstr(alphcar’)’;
freq = freq(pos);
[ofreq, ix] = sort(freq,’descend’);
C.alphab = alphcell(ix);
C.freq = ofreq;
n = length(C.freq); C.cwords = cell(1,n);
for i = 1:ceil(log2(n))
c = cellstr(num2str(dec2bin(0:(2\hat{ }i- ))));
c = c(1:min((n − 2\hat{ }i + 2), 2\hat{ }i));
C.cwords((2\hat{ }i−1):min(n, (2\hat{ }(i+1)−2)))=c;
end
function B = dualencode(A1,C,Hf)
A = strcat(A1{:});
A = regexprep (A,’ ’,’’); A = upper(A);
n = length(A); pos = zeros(1,n);
for i = 1:n
pos(i) = strmatch(A(i), C.alphab);
end
B.rob = ’’;
for i = 1:n
B.rob = strcat(B.rob, C.cwords(pos(i)));
end
B.rob = char(B.rob);
frag = [ ];
for i = 1:n
frag = [frag length(C.cwords{pos(i)})];
end
B.hfrag = ...
huffencode(cellstr(num2str(B.frag)),Hf);

While the instant invention has been disclosed and described with reference to a single embodiment thereof, it will be apparent, as noted above that variations and modifications may be made therein. It is also noted that the instant invention is independent of the machine being controlled, and is not limited to the control of inserting machines. It is, thus, intended in the following claims to cover each variation and modification that falls within the true spirit and scope of the instant invention.

What is claimed is:

1. A method of encoding a message, the method comprising the steps of:
performing two-channel encoding of the message into a robust string and a fragile string;
transmitting the robust string through a fragile channel; and
transmitting the fragile string though a robust channel.

2. The method of claim 1 comprising the further step of:
reducing the number of characters in the message before the step of performing two-channel encoding of the message into a robust string and a fragile string.

3. The method of claim 2 wherein the reducing step comprises at least one of the steps of:
eliminating spaces in the message;
combining common adjacent pairs of letters as one coded character; and
formatting the message to lower case.

4. The method of claim 1 wherein the two-channel encoding step comprises the steps of:
creating the robust string by encoding the message using the codeword dictionary; and
creating the fragile string by encoding the message using a compression algorithm.

5. The method of claim 1 wherein the robust string is transmitted by embedding the robust string in an image.

6. The method of claim 1 wherein the fragile string is transmitted by embedding the fragile string in a 2-D bar code.

7. The method of claim 1 wherein the codeword dictionary comprises a unique code for at least each of the characters in the message.

8. The method of claim 6 wherein the unique codes are based on statistical usage of the characters in a predetermined number of messages.

9. A method of decoding a message encoded in an image and 2-D bar code printed on a document, the method comprising the steps of:
reading a fragile string from the 2-D bar code and reading a robust string from the image;
decoding the fragile string using a decompression algorithm; and
decoding the robust string using a codeword dictionary.

10. A method of decoding a message transmitted in a robust channel and a fragile channel on a document, the method comprising the steps of:
reading a fragile string from a robust channel and reading a robust string from the fragile channel;
decoding the fragile string using a decompression algorithm; and
decoding the robust string using a codeword dictionary.
